(19) United States
(12) Patent Application Publication
(10) Pub. No.: US 2010/0121648 A1
(43) Pub. Date: May 13, 2010

(54) AUDIO FREQUENCY ENCODING AND DECODING METHOD AND DEVICE

(76) Inventors: Benhao Zhang, Shanghai (CN); Heyun Huang, Shanghai (CN); Tan Li, Shanghai (CN); Fuhui Lin, Shanghai (CN)

Correspondence Address: DORSEY & WHITNEY LLP;INTELLECTUAL PROPERTY DEPARTMENT, SUITE 1500, 50 SOUTH SIXTH STREET, MINNEAPOLIS, MN, 55402-1498, US

(21) Appl. No.: 12/615,965

(22) Filed: Nov. 10, 2009

Related U.S. Application Data
(63) Continuation of application No. PCT/CN2008/070987, filed on May 16, 2008.

(30) Foreign Application Priority Data
May 16, 2007 (CN) 200710040710.7

(51) Int. Cl. G10L 21/00

(52) U.S. Cl. 704/500; 704/E21.001

(57) ABSTRACT

An audio encoding method and a corresponding decoding method are provided according to the present invention. Accordingly, the pre-echo effect of the audio transient signal is eliminated and the distortion of the transient signal is mitigated. The technical solution includes performing time-domain processing on an input audio transient signal; dividing sampling points x₁, x₂, . . . , x_{N} of an input frame into L segments, where N is the length of the input frame and L is an arbitrary natural number less than or equal to N; calculating an energy Eᵢ for each segment, where i is a natural number between 1˜L; calculating an average energy E₀ for each segment of the input frame; calculating a multiplying parameter λᵢ corresponding to each segment by virtue of λᵢ=r(bitrate)*E₀/Eᵢ, where i is a natural number between 1˜L and r(bitrate) is a bit rate related function; multiplying the sampling points of all the segments of the input frame by corresponding multiplying parameter λᵢ, obtaining the processed sampling points x_{1′}, x_{2′}, . . . , x_{N′}; and sending the multiplying parameter λᵢ to a code stream for transportation; performing time-frequency transformation and coding on the processed sampling points x_{1′}, x_{2′}, . . . , x_{N′} and outputting to the code stream. The present invention is applicable to mobile communication.

### FIELD OF THE INVENTION

The present invention relates to encoding/decoding method and apparatus thereof, and more specifically, to audio encoding/decoding method and apparatus thereof.

### BACKGROUND

Transient signal is a special audio signal, which often exists in an audio sequence produced by musical instruments including a percussion instrument. For instance, a signal produced by continuously striking the percussion instrument may be referred to as a transient signal. Such signal is characterized in that if the signal is encoded by a conventional transformation, such as Modified Discrete Cosine Transformation (MDCT), a pre-echo effect may occur due to the presence of the quantization noise. The pre-echo effect is caused by the quantization noise due to insufficient number of quantization bits. The quantization noise is distributed evenly into the whole time domain. The signal before the appearance of the transient signal may be occupied by the quantization noise and thus causing the pre-echo effect. Pre-echo effect is an audio distortion which human ears can hardly bear. Thus, there is a need for a special method for encoding or decoding a transient signal.

Two conventional techniques are available to process such transient signal. One is to switch between long and short windows, while the other is to perform noise rectification in time domain. The switching between long and short windows requires a large amount of computational overhead and caches. The method of noise rectification in time domain rectifies the distribution of the quantization noise in time domain based on the result of self-adaptive estimation in frequency domain. This method is relatively simple, but may result in some distortions since the time-domain envelope is not extracted thoroughly.

### SUMMARY

The present invention is aimed at addressing the above question and therefore provides an audio encoding method and a corresponding decoding method. Accordingly, the pre-echo effect of the audio transient signal can be eliminated and the distortion of the transient signal can be mitigated.

According to the present invention, an audio encoding apparatus and a corresponding decoding apparatus are provided. Accordingly, the pre-echo effect of the audio transient signal can be eliminated and the distortion of the transient signal can be mitigated.

An audio encoding method for encoding a transient signal is provided according to the present invention. The method includes:

performing time-domain processing on an input audio transient signal and obtaining a new time-domain signal;

dividing sampling points x₁, x₂, . . . , x_{N} of an input frame into L segments, where N is the length of the input frame and L is an arbitrary natural number less than or equal to N;

calculating an energy Eᵢ for each segment, where i is a natural number between 1˜L;

calculating an average energy E₀ for each segment of the input frame;

calculating a multiplying parameter λᵢ corresponding to each segment by virtue of λᵢ=r(bitrate)*E₀/Eᵢ, where i is a natural number between 1˜L and r(bitrate) is a bit rate related function;

multiplying the sampling points of all the segments of the input frame by corresponding multiplying parameter λᵢ, obtaining the processed sampling points x_{1′}, x_{2′}, . . . , x_{N′}; and sending the multiplying parameter λᵢ to a code stream for transportation;

performing time-frequency transformation and coding on the processed sampling points x_{1′}, x_{2′}, . . . , x_{N′} and outputting to the code stream.

In the above audio encoding method, the sampling points x₁, x₂, . . . , x_{N} of the input frame are divided evenly into 32 segments.

In the above audio encoding method, the sampling points x₁, x₂, . . . , x_{N} of the input frame are divided evenly into 16 segments.

In the above audio encoding method, the sampling points x₁, x₂, . . . , x_{N} of the input frame are divided into a plurality of even or uneven segments according to a position where transient effect takes place.

In the above audio encoding method, the formula for calculating the energy of each segment is

$${E}_{i} = {\sum }_{n ∈ {A}_{i}} {x}_{n}^{2} ,$$

where Aᵢ indicates a segment of the input frame.

In the audio encoding method, the formula for calculating the average energy of the current input frame is

$${E}_{0} = \frac{1}{L} {\sum }_{i = 1}^{L} {E}_{i} .$$

In the above audio encoding method, bit rate BR in the bit rate related function r(bitrate) is a self variable, wherein the self variable BR refers to an average bit rate of an audio channel; when BR<35 k, the value of function is 15.0; when 35 k≦BR<37.5 k, the value of function is 10.0; when 37.5 k≦BR<40 k, the value of function is 8.5; when 40 k≦BR<42.5 k, the value of function is 7.0; when 42.5 k≦BR<45 k, the value of function is 6.0; when 45 k≦BR<47.5 k, the value of function is 4.8; when 47.5 k≦BR<50 k, the value of function is 3.9; when 50 k≦BR<52.5 k, the value of function is 3.6; when 52.5 k≦BR<55 k, the value of function is 3.4; when 55 k≦BR<57.5 k, the value of function is 2.2; when 57.5 k≦BR<60 k, the value of function is 1.5; when 60 k≦BR<62.5 k, the value of function is 1.2; when BR≧62.5 k, the value of function is 1.1.

An audio encoding method for encoding a transient signal is provided according to the present invention. The method includes:

performing time-domain processing on an input audio transient signal;

dividing sampling points x₁, x₂, . . . , x_{N} of an input frame into L segments, where N is the length of the input frame and L is an arbitrary natural number less than or equal to N;

calculating an energy Eᵢ for each segment, where i is a natural number between 1˜L;

calculating an average energy E₀ for each segment of the input frame;

for each segment of the input frame, comparing the product of a bit related function r and E₀/Eᵢ with a threshold T;

for segment Aᵢ for which the product is less than the threshold T, multiplying the sampling points of the segment with the multiplying parameter λᵢ, where λᵢ=r(bitrate)*E₀/Eᵢ;

transporting these multiplying parameters to the code stream and obtaining the processed sampling points x_{1′}, x_{2′}, . . . , x_{N′};

performing time-frequency transformation and coding on the processed sampling points x_{1′}, x_{2′}, . . . , x_{N′}, and outputting to the code stream.

In the above audio encoding method, the sampling points x₁, x₂, . . . , x_{N} of the input frame are divided evenly into 32 segments.

In the above audio encoding method, the sampling points x₁, x₂, . . . , x_{N} of the input frame are divided evenly into 16 segments.

In the above audio encoding method, the sampling points x₁, x₂, . . . , x_{N} of the input frame are divided into a plurality of even or uneven segments according to a position where transient effect takes place.

In the above audio encoding method, the formula for calculating the energy for each segment is

$${E}_{i} = {\sum }_{n ∈ {A}_{i}} {x}_{n}^{2} ,$$

where Aᵢ indicates a segment of the input frame.

In the above audio encoding method, the formula for calculating the average energy for each segment of the input frame is

$${E}_{0} = \frac{1}{L} {\sum }_{i = 1}^{L} {E}_{i} .$$

In the above audio encoding method, the threshold T is predetermined.

In the above audio encoding method, bit rate BR in the bit rate related function r(bitrate) is a self variable, wherein the self variable BR refers to an average bit rate of an audio channel; when BR<35 k, the value of function is 15.0; when 35 k≦BR<37.5 k, the value of function is 10.0; when 37.5 k≦BR<40 k, the value of function is 8.5; when 40 k≦BR<42.5 k, the value of function is 7.0; when 42.5 k≦BR<45 k, the value of function is 6.0; when 45 k≦BR<47.5 k, the value of function is 4.8; when 47.5 k≦BR<50 k, the value of function is 3.9; when 50 k≦BR<52.5 k, the value of function is 3.6; when 52.5 k≦BR<55 k, the value of function is 3.4; when 55 k≦BR<57.5 k, the value of function is 2.2; when 57.5 k≦BR<60 k, the value of function is 1.5; when 60 k≦BR<62.5 k, the value of function is 1.2; when BR≧62.5 k, the value of function is 1.1.

An audio decoding method for decoding a transient signal is provided according to the present invention. The method includes:

performing frequency-time transformation on the code stream and the obtaining processed sampling points x_{1′}, x_{2′}, . . . x_{N′};

obtaining a multiplying parameter λᵢ from the code stream;

dividing each of the sampling points x_{1′}, x_{2′}, . . . , x_{N′} by its corresponding multiplying parameters λᵢ and obtaining original sampling points x₁, x₂, . . . , x_{N};

performing time-domain processing and synthesizing a time-domain signal.

Based on the above method, an audio encoding apparatus for encoding a transient signal is also provided according to the present invention. The apparatus includes:

a time-domain processing module, configured to perform time-domain processing on an input audio transient signal and obtain a new time-domain signal;

a dividing module, configured to divide sampling points x₁, x₂, . . . , x_{N} of an input frame into L segments, where N is the length of the input frame and L is an arbitrary natural number less than or equal to N;

a segment energy calculating module, configured to calculate an energy E, for each segment, where i is a natural number between 1˜L;

a module for calculating average energy of an input frame, configured to calculate an average energy E₀ for each segment of the input frame;

a multiplying parameter calculating module, configured to calculate a multiplying parameter λᵢ corresponding to each segment by virtue of λᵢ=r(bitrate)*E₀/Eᵢ, where i is a natural number between 1˜L and r(bitrate) is a bit rate related function;

a scaling module, configured to multiply the sampling points of all the segments of the input frame by a corresponding multiplying parameter λᵢ and obtain processed sampling points x_{1′}, x_{2′}, . . . , x_{N′};

a multiplying parameter transport module, configured to send the multiplying parameters λᵢ to a code stream for transportation;

a time-frequency transformation and coding module, configured to perform time-frequency transformation and coding on the processed sampling points x_{1′}, x_{2′}, . . . , x_{N′} and output to the code stream.

In the above audio encoding apparatus, the dividing module evenly divides the sampling points x₁, x₂, . . . , x_{N} of the input frame into 32 segments.

In the above audio encoding apparatus, the dividing module evenly divides the sampling points x₁, x₂, . . . , x_{N} of the input frame into 16 segments.

In the above audio encoding apparatus, the dividing module divides the sampling points x₁, x₂, . . . x_{N} of the input frame into a plurality of even or uneven segments according to a position where transient effect takes place.

In the above audio encoding apparatus, the segment energy calculating module calculates the energy for each segment using a formula

$${E}_{i} = {\sum }_{n ∈ {A}_{i}} {x}_{n}^{2} ,$$

where Aᵢ indicates a segment of the input frame.

In the above audio encoding apparatus, the module for calculating average energy of an input frame calculates the average energy of an input frame using a formula

$${E}_{0} = \frac{1}{L} {\sum }_{i = 1}^{L} {E}_{i} .$$

In the above audio encoding apparatus, bit rate BR in the bit rate related function r(bitrate) is a self variable, wherein the self variable BR refers to an average bit rate of an audio channel; when BR<35 k, the value of function is 15.0; when 35 k≦BR<37.5 k, the value of function is 10.0; when 37.5 k≦BR<40 k, the value of function is 8.5; when 40 k≦BR<42.5 k, the value of function is 7.0; when 42.5 k≦BR<45 k, the value of function is 6.0; when 45 k≦BR<47.5 k, the value of function is 4.8; when 47.5 k≦BR<50 k, the value of function is 3.9; when 50 k≦BR<52.5 k, the value of function is 3.6; when 52.5 k≦BR<55 k, the value of function is 3.4; when 55 k≦BR<57.5 k, the value of function is 2.2; when 57.5 k≦BR<60 k, the value of function is 1.5; when 60 k≦BR<62.5 k, the value of function is 1.2; when BR≧62.5 k, the value of function is 1.1.

An audio encoding apparatus for encoding a transient signal is provided according to the present invention. The method includes:

a time-domain processing module, configured to perform time-domain processing on an input audio transient signal and obtain a new time-domain signal;

a dividing module, configured to divide sampling points x₁, x₂, . . . x_{N} of an input frame into L segments, where N is the length of the input frame and L is an arbitrary natural number less than or equal to N;

a segment energy calculating module, configured to calculate an energy Eᵢ for each segment, where i is a natural number between 1˜L;

a module for calculating average energy of an input frame, configured to calculate an average energy E₀ for each segment of the input frame;

a multiplying parameter calculating module, configured to calculate a multiplying parameter λᵢ corresponding to each segment by virtue of λᵢ=r(bitrate)*E₀/Eᵢ, where i is a natural number between 1˜L and r(bitrate) is a bit rate related function;

a determination module, configured to compare a product of the bit related function r and E₀/Eᵢ with a threshold T;

a scaling module, configured to multiply sampling points of a segment Aᵢ for which the product is less than the threshold T by a corresponding multiplying parameter λᵢ and obtain processed sampling points x_{1′}, x_{2′}, . . . , x_{N′};

a multiplying parameter transport module, configured to transport the multiplying parameters λᵢ to a code stream;

a time-frequency transformation and coding module, configured to perform time-frequency transformation and coding on the processed sampling points x_{1′}, x_{2′}, . . . , x_{N′} and output to the code stream.

In the above audio encoding apparatus, the dividing module evenly divides the sampling points x₁, x₂, . . . , x_{N} of the input frame into 32 segments.

In the above audio encoding apparatus, the dividing module evenly divides the sampling points x₁, x₂, . . . , x_{N} of the input frame into 16 segments.

In the above audio encoding apparatus, the dividing module divides the sampling points x₁, x₂, . . . , x_{N} of the input frame into a plurality of even or uneven segments according to a position where transient effect takes place.

In the above audio encoding apparatus, the segment energy calculating module calculates the energy for each segment using a formula

$${E}_{i} = {\sum }_{n ∈ {A}_{i}} {x}_{n}^{2} ,$$

where Aᵢ indicates a segment of the input frame.

In the above audio encoding apparatus, the module for calculating average energy of an input frame calculates the average energy of an input frame using a formula

$${E}_{0} = \frac{1}{L} {\sum }_{i = 1}^{L} {E}_{i} .$$

In the above audio encoding apparatus, the threshold T for the determination module is predetermined.

In the above audio encoding apparatus, bit rate BR in the bit rate related function r(bitrate) is a self variable, wherein the self variable BR refers to an average bit rate of an audio channel; when BR<35 k, the value of function is 15.0; when 35 k≦BR<37.5 k, the value of function is 10.0; when 37.5 k≦BR<40 k, the value of function is 8.5; when 40 k≦BR<42.5 k, the value of function is 7.0; when 42.5 k≦BR<45 k, the value of function is 6.0; when 45 k≦BR<47.5 k, the value of function is 4.8; when 47.5 k≦BR<50 k, the value of function is 3.9; when 50 k≦BR<52.5 k, the value of function is 3.6; when 52.5 k≦BR<55 k, the value of function is 3.4; when 55 k≦BR<57.5 k, the value of function is 2.2; when 57.5 k≦BR<60 k, the value of function is 1.5; when 60 k≦BR<62.5 k, the value of function is 1.2; when BR≧62.5 k, the value of function is 1.1.

An audio decoding apparatus for decoding a transient signal is provided according to the present invention. The apparatus includes:

a frequency-time transformation module, configured to perform a frequency-time transformation on a code stream to obtain processed sampling points x_{1′}, x_{2′}, . . . , x_{N′};

a multiplying parameter obtaining module, configured to obtain a multiplying parameter λᵢ from the code stream;

an anti-scaling module, configured to divide each of the sampling points x_{1′}, x_{2′}, . . . , x_{N′} by its corresponding multiplying parameters λᵢ and obtain the original sampling points x₁, x₂, . . . , x_{N};

a time-domain processing module, configured to perform time-domain processing on the sampling points and synthesize a time-domain signals.

Compared with the prior arts, the present invention enjoys the following advantages. By performing a scaling process on the time-domain sampling points of the input frame before the transient signal is transformed and encoded at the encoding end and by performing an anti-scaling process on the signal to recover the original signal at the decoding end, the present invention succeeds in eliminating the pre-echo effect of the audio transient signal and thus mitigating the distortion of the transient signal.

### BRIEF DESCRIPTION OF THE DRAWINGS

FIG. 1 is a flow diagram of an audio encoding method according to a preferred embodiment of the present invention;

FIG. 2 is a flow diagram of an audio encoding method according to another preferred embodiment of the present invention;

FIG. 3 is a flow diagram of an audio decoding method according to a preferred embodiment of the present invention;

FIG. 4 is a block diagram of an audio encoding apparatus according to a preferred embodiment of the present invention;

FIG. 5 is a block diagram of an audio encoding apparatus according to another preferred embodiment of the present invention; and

FIG. 6 is a block diagram of an audio decoding apparatus according to a preferred embodiment of the present invention.

### PREFERRED EMBODIMENT OF THE PRESENT INVENTION

Detailed description will be made to the present invention in conjunction with the embodiments and the accompanying drawings.

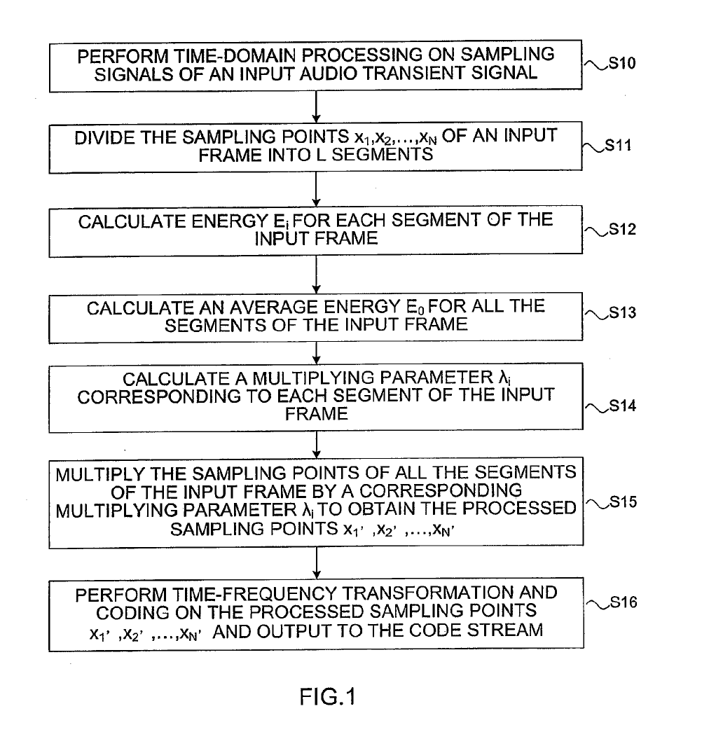

FIG. 1 is a flow diagram of an audio encoding method according to a preferred embodiment of the present invention. Detailed description is made below to each step in the method with reference to FIG. 1.

At step S10, an input audio transient signal is processed in time domain and a new time-domain signal is thus obtained. This is a traditional signal processing step, including designing filter sets, controlling gain, selecting long and short windows, etc.

At step S11, sampling points x₁, x₂, . . . , x_{N} of an input frame are divided into L segments, where N is the length of the input frame and L is an arbitrary natural number less than or equal to N. These sampling points x₁, x₂, . . . , x_{N} are divided into

$$\{ \begin{matrix}{x}_{{l}_{0}} , \\ {x}_{{l}_{{l}_{0}} + 1} , … , {x}_{{l}_{1}}\end{matrix} \} , \{ \begin{matrix}{x}_{{l}_{1} + 1} , \\ {x}_{{l}_{1} + 2} , … , {x}_{{l}_{2}}\end{matrix} \} , … , \{ \begin{matrix}{x}_{{l}_{L - 1} + 1} , \\ {x}_{{l}_{L - 1} + 2} , … , {x}_{{l}_{L}}\end{matrix} \} ,$$

where 1₀=1, 1_{L}=N.

There are various methods for segmentation. All sampling points can be evenly divided into 32 segments. Alternatively, all sampling points can be evenly divided into 16 segments. Or, all the sampling points can be divided into several even or uneven segments.

At step S12, the energy Eᵢ for each segment of the input frame is calculated, where i is a natural number between 1˜L. The calculation formula is given by

$${E}_{i} = {\sum }_{n ∈ {A}_{i}} {x}_{n}^{2} ,$$

where Aᵢ indicates a segment in the input frame.

At step S13, an average energy E₀ for each segment of the current input frame is computed. The calculation formula is

$${E}_{0} = \frac{1}{L} {\sum }_{i = 1}^{L} {E}_{i} .$$

At step S14, the multiplying parameter λᵢ corresponding to each segment of the input frame is calculated by formula λᵢ=r(bitrate)*E₀/Eᵢ, where i is a natural number between 1˜L.

The function r(bitrate) herein is a bit rate related function. Its self variable BR refers to bit rate, indicating the bit rate of a channel. For instance, there are currently two channels and the total bit rate is 120 k, then the self variable BR is 120K/2=60 k. The function is detailed in the below table.

| Self variable BR | value r of |
|---|---|
| (bit rate of a channel) | the function |
| BR < 35k | 15.0 |
| 35k ≦ BR < 37.5k | 10.0 |
| 37.5k ≦ BR < 40k | 8.5 |
| 40k ≦ BR < 42.5k | 7.0 |
| 42.5k ≦ BR < 45k | 6.0 |
| 45k ≦ BR < 47.5k | 4.8 |
| 47.5k ≦ BR < 50k | 3.9 |
| 50k ≦ BR < 52.5k | 3.6 |
| 52.5k ≦ BR < 55k | 3.4 |
| 55k ≦ BR < 57.5k | 2.2 |
| 57.5k ≦ BR < 60k | 1.5 |
| 60k ≦ BR < 62.5k | 1.2 |
| BR ≧ 62.5k | 1.1 |

At step S15, the sampling points of all the segments of the input frame are multiplied by the multiplying parameter λᵢ so that processed sampling points x_{1′}, x_{2′}, . . . , x_{N′} are obtained. At the same time, these multiplying parameters λᵢ are transported into a code stream. The scaling formula is given by x′ₙ=x_{nλ}ᵢ, xₙε{xₗ_{_{i−1}}₊₁, xₗ_{_{i−1}}₊₂, . . . , xₗ_{ᵢ}}.

At step S16, the processed sampling points x_{1′}, x_{2′}, . . . , x_{N′} are output to the code stream after time-frequency transformation and coding.

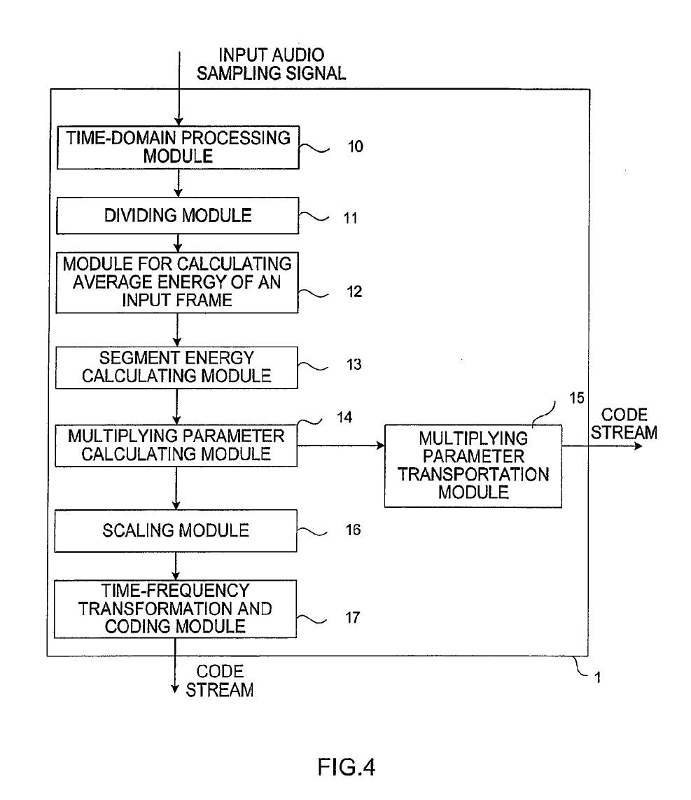

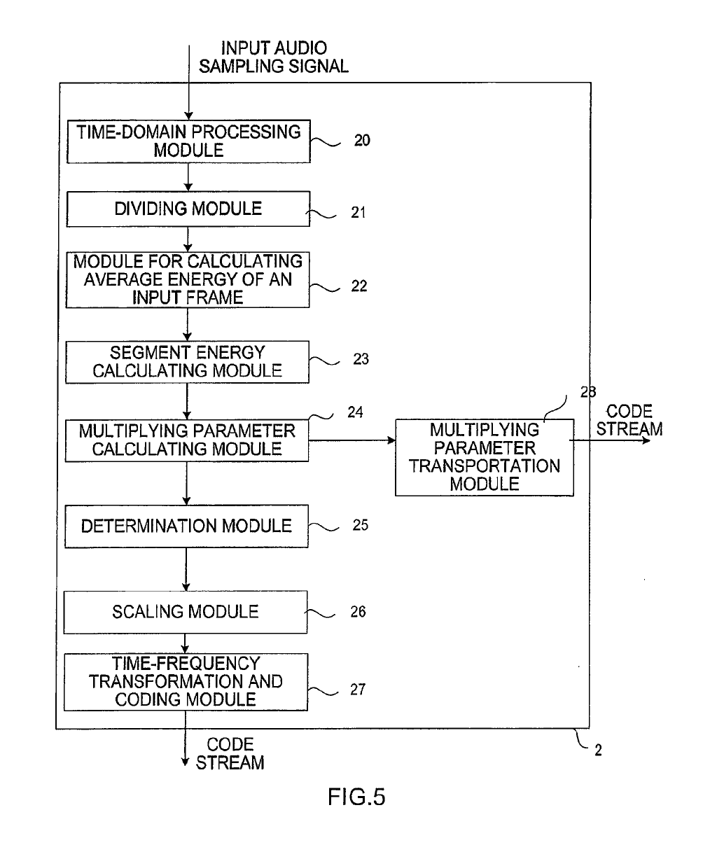

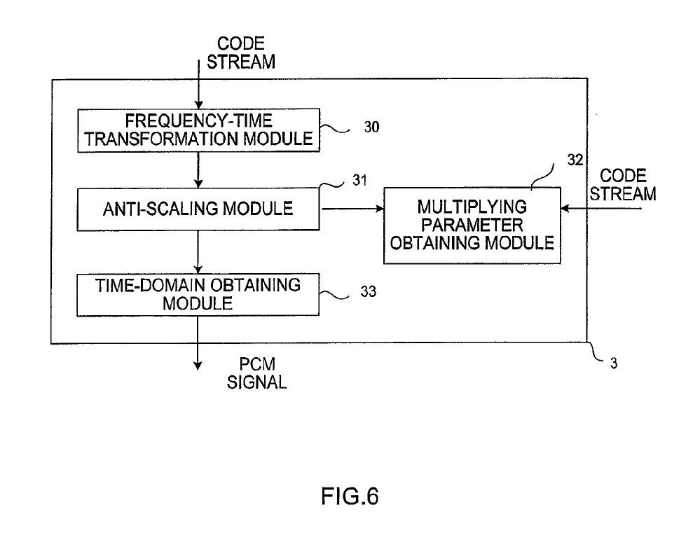

Based on the above method, an audio encoding apparatus is also provided according to the present invention, as illustrated in FIG. 4. The audio encoding apparatus 1 includes a time-domain processing module 10, a dividing module 11, a module for calculating average energy of an input frame 12, a segment energy calculating module 13, a multiplying parameter calculating module 14, a multiplying parameter transportation module 15, a scaling module 16 and a time-frequency transformation and coding module 17.

The time-domain processing module 10 processes the input audio transient signal in time domain and obtains a new time-domain signal. The time-frequency processing module 10 includes traditional filter sets, a gain control module, a long-and-short window selecting module, etc. The dividing module 11 divides sampling points x₁, x₂, . . . , x_{N} of an input frame into L segments, where N is the length of the input frame and L is an arbitrary natural number less than or equal to N. These sampling points x₁, x₂, . . . , x_{N} are divided into

$$\{ \begin{matrix}{x}_{{l}_{0}} , \\ {x}_{{l}_{{l}_{0}} + 1} , … , {x}_{{l}_{1}}\end{matrix} \} , \{ \begin{matrix}{x}_{{l}_{1} + 1} , \\ {x}_{{l}_{1} + 2} , … , {x}_{{l}_{2}}\end{matrix} \} , … , \{ \begin{matrix}{x}_{{l}_{L - 1} + 1} , \\ {x}_{{l}_{L - 1} + 2} , … , {x}_{{l}_{L}}\end{matrix} \} ,$$

where 1₀=1, 1_{L}=N. There are various methods for segmentation. All sampling points can be evenly divided into 32 segments. Alternatively, all sampling points can be evenly divided into 16 segments. Or, all the sampling points can be divided into several even or uneven segments according to the position where transient effect takes place.

The segment energy calculating module 13 calculates the energy E, for each segment of the input frame, where i is a natural number 1˜L. Eᵢ is given by formula

$${E}_{i} = {\sum }_{n ∈ {A}_{i}} {x}_{n}^{2} ,$$

where Aᵢ indicates a segment of the input frame. The module for calculating average energy of an input frame 12 calculates the average energy E₀ for each segment of the current input frame. The calculation formula is

$${E}_{0} = \frac{1}{L} {\sum }_{i = 1}^{L} {E}_{i} .$$

The multiplying parameter calculating module 14 calculates a multiplying parameter λᵢ corresponding to each segment of the input frame. The calculation formula is λᵢ=r(bitrate)*E₀/Eᵢ, where i is a natural number between 1˜L and r(bitrate) is a bit rate related function. The form of the function r(bitrate) may refer to the table depicted the above embodiment, which is omitted herein for brevity. The multiplying parameter transport module 15 sends these multiplying parameters to a code stream for transportation. The scaling module 16 multiplies the sampling points of all the segments of the input frame by the multiplying parameter λᵢ so that processed sampling points x_{1′}, x_{2′}, . . . , x_{N′}, are obtained. The scaling formula is x′ₙ=xₙλᵢ, xₙε{xₗ_{_{i−1}}₊₁, xₗ_{_{i−1}}₊₂, . . . , xₗ_{ᵢ}}. The time-frequency transformation and coding module 17 performs time-frequency transformation and coding on the processed sampling points x_{1′}, x_{2′}, . . . , x_{N′} and output to the code stream.

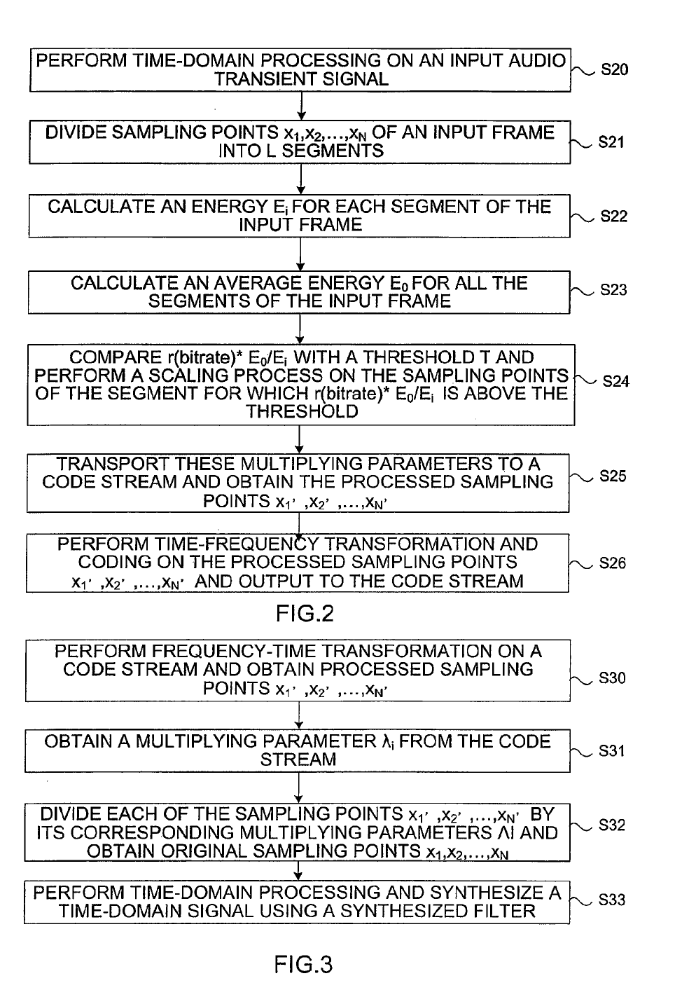

FIG. 2 is a flow diagram of an audio encoding method according to another preferred embodiment of the present invention. Each step is detailed below with reference to FIG. 2.

At step S20, an input audio transient signal is processed in time domain. This is a traditional signal processing step, including designing filter sets, controlling gain, selecting long and short windows, etc.

At step S21, sampling points x₁, x₂, . . . , x_{N} of an input frame are divided into L segments, where N is the length of the input frame and L is an arbitrary natural number less than or equal to N. These sampling points x₁, x₂, . . . , x_{N} are divided into

$$\{ \begin{matrix}{x}_{{l}_{0}} , \\ {x}_{{l}_{{l}_{0}} + 1} , … , {x}_{{l}_{1}}\end{matrix} \} , \{ \begin{matrix}{x}_{{l}_{1} + 1} , \\ {x}_{{l}_{1} + 2} , … , {x}_{{l}_{2}}\end{matrix} \} , … , \{ \begin{matrix}{x}_{{l}_{L - 1} + 1} , \\ {x}_{{l}_{L - 1} + 2} , … , {x}_{{l}_{L}}\end{matrix} \} ,$$

where 1₀=1, 1_{L}=N.

There are various methods for segmentation. All sampling points can be evenly divided into 32 segments. Alternatively, all sampling points can be evenly divided into 16 segments. Or, all the sampling points can be divided into several even or uneven segments according to the position where transient effect takes place.

At step S22, the energy Eᵢ for each segment of the input frame is calculated, where i is a natural number between 1˜L. The calculation formula is

$${E}_{i} = {\sum }_{n ∈ {A}_{i}} {x}_{n}^{2} ,$$

where Aᵢ indicates a segment of the input frame.

At step S23, an average energy E₀ for all the segments of the input frame is computed. The calculation formula is given by

$${E}_{0} = \frac{1}{L} {\sum }_{i = 1}^{L} {E}_{i} .$$

At step S24, for each segment Aᵢ of the input frame, the product of the bit rate related function r(bitrate) and E₀/E, is compared with a threshold T, i.e., r(bitrate)*E₀/Eᵢ is compared with the threshold T.

For segment Aᵢ for which the product is less than the threshold T, the sampling points of this segment is multiplied with the multiplying parameter λᵢ, where λᵢ=r(bitrate)*E₀/Eᵢ. That is, scalability is performed on some segment Aᵢ, i.e., x′ₙ=xₙλᵢ, xₙε{xₗ_{_{i−1}}₊₁, xₗ_{_{i−1}}₊₂, . . . xₗ_{ᵢ}}. However, the sampling points of other segments are not scaled.

The threshold T is pre-determined and arbitrary, and function r(bitrate) is a bit rate related function. Different bit rate results in different value of the function. The details may refer to the table depicted the first embodiment, which is omitted herein for brevity.

At step S25, these multiplying parameters are transported to the code stream and the processed sampling points x_{1′}, x_{2′}, . . . , x_{N′} are thus obtained.

At step S26, the processed sampling points x_{1′}, x_{2′}, . . . , x_{N′} are output to the code stream after time-frequency coding and transformation.

Based on the above method, an audio encoding apparatus is also provided according to the present invention, as illustrated in FIG. 5. The audio encoding apparatus 2 includes a time-domain processing module 20, a dividing module 21, a module for calculating average energy of an input frame 22, a segment energy calculating module 23, a multiplying parameter calculating module 24, a determination module 25, a scaling module 26, a time-frequency transformation and coding module 27 and a multiplying parameter transportation module 25.

The time-frequency processing module 20 processes the input audio transient signal in time domain and obtains a new time-domain signal. The time-frequency processing module 20 includes traditional filter sets, a gain control module, a long-and-short window selecting module, etc. The dividing module 21 divides sampling points x₁, x₂, . . . , x_{N} of an input frame into L segments, where N is the length of the input frame and L is an arbitrary natural number less than or equal to N. These sampling points x₁, x₂, . . . , x_{N} are divided into

$$\{ \begin{matrix}{x}_{{l}_{0}} , \\ {x}_{{l}_{{l}_{0}} + 1} , … , {x}_{{l}_{1}}\end{matrix} \} , \{ \begin{matrix}{x}_{{l}_{1} + 1} , \\ {x}_{{l}_{1} + 2} , … , {x}_{{l}_{2}}\end{matrix} \} , … , \{ \begin{matrix}{x}_{{l}_{L - 1} + 1} , \\ {x}_{{l}_{L - 1} + 2} , … , {x}_{{l}_{L}}\end{matrix} \} ,$$

where 1₀=1, 1_{L}=N. There are various methods for segmentation. All sampling points can be evenly divided into 32 segments. Alternatively, all sampling points can be evenly divided into 16 segments. Or, all the sampling points can be divided into several even or uneven segments according to the position where transient effect takes place.

The segment energy calculating module 23 calculates the energy Eᵢ for each segment of the input frame, where i is a natural number 1˜L. Eᵢ is given by

$${E}_{i} = {\sum }_{n ∈ {A}_{i}} {x}_{n}^{2} ,$$

where Aᵢ indicates a segment of the input frame. The module for calculating average energy of an input frame 22 calculates the average energy E₀ for all the segments of the input frame. The calculation formula is

$${E}_{0} = \frac{1}{L} {\sum }_{i = 1}^{L} {E}_{i} .$$

The multiplying parameter calculating module 24 calculates a multiplying parameter λᵢ corresponding to each segment of the input frame. The calculation formula is λᵢ=r(bitrate)*E₀/Eᵢ, where i is a natural number between 1˜L and r(bitrate) is a bit rate related function. Different bit rate results in different value of the function. The details may refer to the table depicted the first embodiment, which is omitted herein for brevity. The multiplying parameter transport module 28 transports these multiplying parameters to a code stream.

For each segment A; of the input frame, the determination module 25 compares the product of the bit rate related function r(bitrate) and E₀/Eᵢ with a threshold T, i.e., r(bitrate)*E₀/Eᵢ is compared with T. For a segment for which the product is less than T, the scaling module 26 multiplies the sampling points of this segment with a corresponding multiplying parameter λᵢ, where λᵢ=r(bitrate)*E₀/Eᵢ. That is, scalability is performed on some segment Aᵢ, i.e., x′ₙ=xₙλᵢ, xₙε{xₗ_{_{i−1}}₊₁, xₗ_{_{i−1}}₊₂, . . . , xₗ_{ᵢ}}. The time-frequency transformation and coding module 27 performs time-frequency transformation and coding on the processed sampling points x_{1′}, x_{2′}, . . . , x_{N′} and output to the code stream.

Based on the encoding method of the above embodiment, a decoding method corresponding to the encoding method is proposed by the present invention. Each step in the decoding method according to a preferred embodiment is detailed below with reference to FIG. 3.

At step S30, time-frequency transformation is performed on a code stream and the processed sampling points x_{1′}, x_{2′}, . . . , x_{N′} are obtained. This step is an inverse step of S26 in FIG. 2.

At step S31, the multiplying parameter λᵢ is obtained from the code stream.

At step S32, the sampling points x_{1′}, x_{2′}, . . . , x_{N′} are divided by their corresponding multiplying parameters λᵢ and original sampling points x₁, x₂, . . . , x_{N} are thus obtained. That is, each segment is processed in the following way:

$${x}_{n} = \frac{{x}_{n}^{′}}{{λ}_{i}} , {x}_{n}^{′} ∈ \{ {x}_{{l}_{i - 1} + 1}^{′} , {x}_{{l}_{i - 1} + 2}^{′} , … , {x}_{{l}_{i}}^{′} \} .$$

In fact, such step is an inverse process of step S15 or S24 in the embodiment where encoding is described.

At step S33, time domain processing is performed and a synthesized filter is employed to synthesize the signal in time domain. This step is an inverse process of step S10 or S20 in the embodiment where encoding is described.

Based on the above method, an audio decoding apparatus is provided according to the present invention. The audio decoding apparatus 6 includes a frequency-time transformation module 30, an anti-scaling module 31, a multiplying parameter obtaining module 32 and a time-domain processing module 33. The frequency-time transformation module 30 performs a frequency-time transformation on a code stream to obtain sampling points x_{1′}, x_{2′}, . . . , x_{N′}. The multiplying parameter obtaining module 32 obtains the multiplying parameter λᵢ from the code stream. Then anti-scaling module 31 divides each of the sampling points x_{1′}, x_{2′}, . . . , x_{N′} by its corresponding multiplying parameters λᵢ and obtains the original sampling points x₁, x₂, . . . , x_{N}. The time-domain processing module 33 performs time-domain processing on the sampling points and synthesizes the time-domain signals.

The foregoing embodiments are provided to those skilled in the art for implementation or usage of the present disclosure. Various modifications or alternations may be made by those skilled in the art without departing from the spirit of the present disclosure. Therefore, the foregoing embodiments shall not be construed to be limiting to the scope of present disclosure. Rather, the scope of the present disclosure should be construed as the largest scope in accordance with inventive features as recited in the claims.

What is claimed is:

1. An audio encoding method for encoding a transient signal, comprising:
performing time-domain processing on an input audio transient signal and obtaining a new time-domain signal;
dividing sampling points x₁, x₂, . . . , x_{N} of an input frame into L segments, where N is the length of the input frame and L is an arbitrary natural number less than or equal to N;
calculating an energy Eᵢ for each segment, where i is a natural number between 1˜L;
calculating an average energy E₀ for each segment of the input frame;
calculating a multiplying parameter λᵢ corresponding to each segment by virtue of λᵢ=r(bitrate)*E₀/Eᵢ, where i is a natural number between 1˜L and r(bitrate) is a bit rate related function;
multiplying the sampling points of all the segments of the input frame by corresponding multiplying parameter λᵢ, obtaining the processed sampling points x_{1′}, x_{2′}, . . . , x_{N′}; and sending the multiplying parameter λᵢ to a code stream for transportation; and
performing time-frequency transformation and coding on the processed sampling points x_{1′}, x_{2′}, . . . , x_{N′}, and outputting to the code stream.

2. The audio encoding method of claim 1, characterized in that, the sampling points x₁, x₂, . . . x_{N} of the input frame are divided evenly into 32 segments.

3. The audio encoding method of claim 1, characterized in that, the sampling points x₁, x₂, . . . , x_{N} of the input frame are divided evenly into 16 segments.

4. The audio encoding method of claim 1, characterized in that, the sampling points x₁, x₂, . . . , x_{N} of the input frame are divided into a plurality of even or uneven segments according to a position where transient effect takes place.

5. The audio encoding method of claim 1, characterized in that, the formula for calculating the energy for each segment is
$${E}_{i} = {\sum }_{n ∈ {A}_{i}} {x}_{n}^{2} ,$$
where Aᵢ indicates a segment of the input frame.

6. The audio encoding method of claim 5, characterized in that, the formula for calculating the average energy for the current input frame is
$${E}_{0} = \frac{1}{L} {\sum }_{i = 1}^{L} {E}_{i} .$$

7. The audio encoding method of claim 1, characterized in that, bit rate BR in the bit rate related function r(bitrate) is a self variable, wherein the self variable BR refers to an average bit rate of an audio channel; when BR<35 k, the value of function is 15.0; when 35 k≦BR<37.5 k, the value of function is 10.0; when 37.5 k≦BR<40 k, the value of function is 8.5; when 40 k≦BR<42.5 k, the value of function is 7.0; when 42.5 k≦BR<45 k, the value of function is 6.0; when 45 k≦BR<47.5 k, the value of function is 4.8; when 47.5 k≦BR<50 k, the value of function is 3.9; when 50 k≦BR<52.5 k, the value of function is 3.6; when 52.5 k≦BR<55 k, the value of function is 3.4; when 55 k≦BR<57.5 k, the value of function is 2.2; when 57.5 k≦BR<60 k, the value of function is 1.5; when 60 k≦BR<62.5 k, the value of function is 1.2; when BR≧62.5 k, the value of function is 1.1.

8. An audio encoding method for encoding a transient signal, comprising:
performing time-domain processing on an input audio transient signal;
dividing sampling points x₁, x₂, . . . , x_{N} of an input frame into L segments, where N is the length of the input frame and L is an arbitrary natural number less than or equal to N;
calculating an energy Eᵢ for each segment, where i is a natural number between 1˜L;
calculating an average energy E₀ for each segment of the input frame;
for each segment of the input frame, comparing a product of a bit related function r and E₀/Eᵢ with a threshold T;
for segment Aᵢ for which the product is less than the threshold T, multiplying the sampling points of the segment by the corresponding multiplying parameter λᵢ, where λᵢ=r(bitrate)*E₀/Eᵢ;
transporting these multiplying parameters to a code stream and obtaining the processed sampling points x_{1′}, x_{2′}, . . . , x_{N′}; and
performing time-frequency transformation and coding on the processed sampling points x_{1′}, x_{2′}, . . . , x_{N′} and outputting to the code stream.

9. The audio encoding method of claim 8, characterized in that, the sampling points x_{1′}, x_{2′}, . . . , x_{N′} of the input frame are divided evenly into 32 segments.

10. The audio encoding method of claim 8, characterized in that, the sampling points x₁, x₂, . . . , x_{N} of the input frame are divided evenly into 16 segments.

11. The audio encoding method of claim 8, characterized in that, the sampling points x₁, x₂, . . . , x_{N} of the input frame are divided into a plurality of even or uneven segments according to a position where transient effect takes place.

12. The audio encoding method of claim 8, characterized in that, the formula for calculating the energy for each segment is
$${E}_{i} = {\sum }_{n ∈ {A}_{i}} {x}_{n}^{2} ,$$
where Aᵢ indicates a segment of the input frame.

13. The audio encoding method of claim 12, characterized in that, the formula for calculating an average energy for each segment of the input frame is
$${E}_{0} = \frac{1}{L} {\sum }_{i = 1}^{L} {E}_{i} .$$

14. The audio encoding method of claim 8, characterized in that, the threshold T is predetermined.

15. The audio encoding method of claim 8, characterized in that, bit rate BR in the bit rate related function r(bitrate) is a self variable, wherein the self variable BR refers to an average bit rate of an audio channel; when BR<35 k, the value of function is 15.0; when 35 k≦BR<37.5 k, the value of function is 10.0; when 37.5 k≦BR<40 k, the value of function is 8.5; when 40 k≦BR<42.5 k, the value of function is 7.0; when 42.5 k≦BR<45 k, the value of function is 6.0; when 45 k≦BR<47.5 k, the value of function is 4.8; when 47.5 k≦BR<50 k, the value of function is 3.9; when 50 k≦BR<52.5 k, the value of function is 3.6; when 52.5 k≦BR<55 k, the value of function is 3.4; when 55 k≦BR<57.5 k, the value of function is 2.2; when 57.5 k≦BR<60 k, the value of function is 1.5; when 60 k≦BR<62.5 k, the value of function is 1.2; when BR≧62.5 k, the value of function is 1.1.

16. An audio decoding method for decoding a transient signal, comprising:
performing frequency-time transformation on a code stream and obtaining processed sampling points x_{1′}, x_{2′}, . . . , x_{N′};
obtaining a multiplying parameter λᵢ from the code stream;
dividing each of the sampling points x_{1′}, x_{2′}, . . . , x_{N′} by its corresponding multiplying parameters λᵢ and obtaining original sampling points x₁, x₂, . . . , x_{N}; and
performing time-domain processing and synthesizing a time-domain signal.

17. An audio encoding apparatus for encoding a transient signal, comprising:
a time-domain processing module, configured to perform time-domain processing on an input audio transient signal and obtain a new time-domain signal;
a dividing module, configured to divide sampling points x₁, x₂, . . . , x_{N} of an input frame into L segments, where N is the length of the input frame and L is an arbitrary natural number less than or equal to N;
a segment energy calculating module, configured to calculate an energy Eᵢ for each segment, where i is a natural number between 1˜L;
a module for calculating average energy of an input frame, configured to calculate the average energy E₀ for each segment of the input frame;
a multiplying parameter calculating module, configured to calculate a multiplying parameter λᵢ corresponding to each segment by virtue of λᵢ=r(bitrate)*E₀/Eᵢ, where i is a natural number between 1˜L and r(bitrate) is a bit rate related function;
a scaling module, configured to multiply the sampling points of all the segments of the input frame by a corresponding multiplying parameter λᵢ and obtain processed sampling points x_{1′}, x_{2′}, . . . , x_{N′};
a multiplying parameter transport module, configured to send the multiplying parameters λᵢ to a code stream for transportation; and
a time-frequency transformation and coding module, configured to perform time-frequency transformation and coding on the processed sampling points x_{1′}, x_{2′}, . . . , x_{N′} and output to the code stream.

18. The audio encoding apparatus of claim 17, characterized in that, the dividing module evenly divides the sampling points x₁, x₂, . . . , x_{N} of the input frame into 32 segments.

19. The audio encoding apparatus of claim 17, characterized in that, the dividing module evenly divides the sampling points x₁, x₂, . . . , x_{N} of the input frame into 16 segments.

20. The audio encoding apparatus of claim 17, characterized in that, the dividing module divides the sampling points x₁, x₂, . . . , x_{N} of the input frame into a plurality of even or uneven segments according to a position where transient effect takes place.

21. The audio encoding apparatus of claim 17, characterized in that, the segment energy calculating module calculates the energy for each segment using the formula
$${E}_{i} = {\sum }_{n ∈ {A}_{i}} {x}_{n}^{2} ,$$
where Aᵢ indicates a segment of the input frame.

22. The audio encoding apparatus of claim 21, characterized in that, the module for calculating average energy of an input frame calculates the average energy of an input frame using a formula
$${E}_{0} = \frac{1}{L} {\sum }_{i = 1}^{L} {E}_{i} .$$

23. The audio encoding apparatus of claim 17, characterized in that, bit rate BR in the bit rate related function r(bitrate) is a self variable, wherein the self variable BR refers to an average bit rate of an audio channel; when BR<35 k, the value of function is 15.0; when 35 k≦BR<37.5 k, the value of function is 10.0; when 37.5 k≦BR<40 k, the value of function is 8.5; when 40 k≦BR<42.5 k, the value of function is 7.0; when 42.5 k≦BR<45 k, the value of function is 6.0; when 45 k≦BR<47.5 k, the value of function is 4.8; when 47.5 k≦BR<50 k, the value of function is 3.9; when 50 k≦BR<52.5 k, the value of function is 3.6; when 52.5 k≦BR<55 k, the value of function is 3.4; when 55 k≦BR<57.5 k, the value of function is 2.2; when 57.5 k≦BR<60 k, the value of function is 1.5; when 60 k≦BR<62.5 k, the value of function is 1.2; when BR≧62.5 k, the value of function is 1.1.

24. An audio encoding apparatus for encoding a transient signal, comprising:
a time-domain processing module, configured to perform time-domain processing on an input audio transient signal and obtain a new time-domain signal;
a dividing module, configured to divide sampling points x₁, x₂, . . . , x_{N} of an input frame into L segments, where N is the length of the input frame and L is an arbitrary natural number less than or equal to N.
a segment energy calculating module, configured to calculate an energy Eᵢ for each segment, where i is a natural number between 1˜L;
a module for calculating average energy of an input frame, configured to calculate the average energy E₀ for each segment of the input frame;
a multiplying parameter calculating module, configured to calculate a multiplying parameter λᵢ corresponding to each segment by virtue of λᵢ=r(bitrate)*E₀/Eᵢ, where i is a natural number between 1˜L, and r(bitrate) is a bit rate related function;
a determination module, configured to compare a product of the bit related function r(bitrate) and E₀/Eᵢ with a threshold T for each segment of the input frame;
a scaling module, configured to multiply the sampling points of a segment Aᵢ for which the product is less than the threshold T by a corresponding multiplying parameter λᵢ and obtain processed sampling points x_{1′}, x_{2′}, . . . , x_{N′};
a multiplying parameter transport module, configured to transport the multiplying parameters λᵢ to a code stream; and
a time-frequency transformation and coding module, configured to perform time-frequency transformation and coding on the processed sampling points x_{1′}, x_{2′}, . . . , x_{N′} and output to the code stream.

25. The audio encoding apparatus of claim 24, characterized in that, the dividing module evenly divides the sampling points x₁, x₂, . . . , x_{N} of the input frame into 32 segments.

26. The audio encoding apparatus of claim 24, characterized in that, the dividing module evenly divides the sampling points x₁, x₂, . . . , x_{N} of the input frame into 16 segments.

27. The audio encoding apparatus of claim 24, characterized in that, the dividing module divides the sampling points x₁, x₂, . . . , x_{N} of the input frame into a plurality of even or uneven segments according to a position where transient effect takes place.

28. The audio encoding apparatus of claim 24, characterized in that, the segment energy calculating module calculates the energy for each segment using a formula
$${E}_{i} = {\sum }_{n ∈ {A}_{i}} {x}_{n}^{2} ,$$
where Aᵢ indicates a segment of the input frame.

29. The audio encoding apparatus of claim 28, characterized in that, the module for calculating average energy of an input frame calculates the average energy for each segment of the input frame using a formula
$${E}_{0} = \frac{1}{L} {\sum }_{i = 1}^{L} {E}_{i} .$$

30. The audio encoding apparatus of claim 24, characterized in that, the threshold T for the determination module is predetermined.

31. The audio encoding apparatus of claim 24, characterized in that, bit rate BR of the bit rate related function r(bitrate) is a self variable, wherein the self variable BR refers to an average bit rate of an audio channel; when BR<35 k, the value of function is 15.0; when 35 k≦BR<37.5 k, the value of function is 10.0; when 37.5 k≦BR<40 k, the value of function is 8.5; when 40 k≦BR<42.5 k, the value of function is 7.0; when 42.5 k≦BR<45 k, the value of function is 6.0; when 45 k≦BR<47.5 k, the value of function is 4.8; when 47.5 k≦BR<50 k, the value of function is 3.9; when 50 k≦BR<52.5 k, the value of function is 3.6; when 52.5 k≦BR<55 k, the value of function is 3.4; when 55 k≦BR<57.5 k, the value of function is 2.2; when 57.5 k≦BR<60 k, the value of function is 1.5; when 60 k≦BR<62.5 k, the value of function is 1.2; when BR≧62.5 k, the value of function is 1.1.

32. An audio decoding apparatus for decoding a transient signal, comprising:
a frequency-time transformation module, configured to perform a frequency-time transformation on a code stream to obtain sampling points x_{1′}, x_{2′}, . . . , x_{N′};
a multiplying parameter obtaining module, configured to obtain multiplying parameter λᵢ from the code stream;
an anti-scaling module, configured to divide each of the sampling points x_{1′}, x_{2′}, . . . , x_{N′} by its corresponding multiplying parameters λᵢ and obtain original sampling points x₁, x₂, . . . , x_{N}; and
a time-domain processing module, configured to perform time-domain processing on the sampling points and synthesize a time-domain signal.
